(19) United States
(12) Patent Application Publication
(10) Pub. No.: US 2021/0189151 A1
(43) Pub. Date: Jun. 24, 2021

(54) COATING COMPOSITION WITH SELENIUM-BASED BIOCIDAL FORMULATIONS

(71) Applicant: Brent Fisher, Austin, TX (US)

(72) Inventor: Brent Fisher, Austin, TX (US)

(21) Appl. No.: 16/989,655

(22) Filed: Aug. 10, 2020

Related U.S. Application Data
(60) Provisional application No. 62/884,756, filed on Aug. 9, 2019.

(51) Int. Cl. C09D 5/14; A01N 55/00; C09D 4/00; C09D 135/02

(52) U.S. Cl. CPC C09D 5/14; C09D 135/02; C09D 4/00; A01N 55/00

(57) ABSTRACT

Coating compositions including and incorporating biocidal compositions containing organoselenium and/or selenium-based compounds are disclosed, as well as methods of producing and using same. For instance, a coating composition comprises covalent linkage of an anchor group to the surface of a substrate, wherein the active group comprises an organic selenium compound acting as a biocidal composition attached to the anchor group.

### I. RELATED APPLICATIONS

This application claims the benefit of U.S. Provisional Application No. 62/884,756, filed on Aug. 9, 2019.

### II. FIELD OF INVENTION

The present application discloses and describes composition(s), system(s), and/or method(s) of forming and/or utilizing coatings having coatings composition(s) incorporating selenium-based biocidal formulation therein, including such coatings as paints, industrial coatings, and similarly manufactured and applied products.

### III. BACKGROUND OF THE INVENTION

Infectious disease, including such sources as bacteria, viruses, pathogenic fungi, protozoa, and the like, pose significant and ever-increasing threats toward many living organisms, and is especially concerning with regard to public health issues with humans as well as maintenance of other animals and animal populations. For example, hospitals and health-care facilities wage a persistent battle against infectious agents manifest via antibiotic resistant bacteria such as well-publicized incidents with MRSA (Methicillin-resistant Staphylococcus aureus), flesh-eating bacteria (usually Group A Streptococci (Streptococcus pyogenes)), as well as antibiotic resistant strains of bacteria that cause pneumonia, diarrhea, meningitis, tuberculosis, and strep-throat, all which are persistent threats to the very young, the elderly, and those with compromised immune systems.

As a result of widespread public concern with infectious disease, antimicrobial treatment of materials such as fabrics, fibers, and polymers have emerged as possible alternatives in preventing the colonization and/or transfer of such infectious disease. While the demand for such antimicrobial articles remains high, relatively few types of such articles are available, and not all of those available are both effective against a broad spectrum of pathogens and capable of sustained antimicrobial activity without being released into the environment or eventually inactivated over time through physical and/or chemical degradation.

In addition, and although less serious than infectious disease, sources as bacteria, viruses, pathogenic fungi, protozoa, and the like, pose separately significant concerns with the facilitation of material growth, such as biofilm formation on many and various types of surfaces. Generally, biofilm formation may yield one or more undesirable results, such as loss of production efficiency, production spoilage, safety concerns, and/or equipment degradation and eventual failure, among several possibilities. For example, in food production and its various subindustries, biofilm formation encourages and/or provides the availability of certain nutrients and favorable temperatures that yield biofilm formation and aggregation that harm production optimization, increase the likelihood of contamination of end-product materials, corrode valuable physical assets (e.g., production vessels, heat exchangers), and generally reduce safety to the manufacturer and to the public that may consume these products, including beverages in the dairy, alcohol, soft-drink, and/or juice industries.

Another example, especially for non-food/non-beverage application, includes activities engaged in underwater, and especially seawater-based environments. Because of the composition of seawater, temperature, and the utilization of certain types of tangible equipment and the materials from which such equipment is manufactured, biofilm formation is a significant problem. In particular, and as but one example, seawater heat exchangers are plagued by fouling during operation, such as particulate and biological film formation. Fouling of heat exchangers is a serious and long-standing problem that can result in decreased heat transfer efficiency, higher resistance to fluid flow, increased energy consumption, decreased heat exchanger lifetime, and increased downtime necessary to replace or clean fouled parts.

Generally, biological fouling is the accumulation of microorganism, plants, algae or animals on the interior of the tube and is the type of fouling most experienced. Turf-like algae growths are increasingly found when operating in warm seawater environments. Presently, entities and organizations, (including the U.S. Navy) use a combination of periodic chlorination and periodic seawater flush to mitigate fouling in titanium seawater heat exchangers. Seawater flushing at velocities of 3 m/s is sufficient to remove most particulates. However, electrolytic chlorinator systems used to remove biological fouling are expensive, difficult to maintain, and ineffective in warm water.

Accordingly, there is a need for an improved selenium-based biocidal composition(s), system(s), and/or method(s). More particularly, there is a need for biocidal agents that both avoid the formation of resistant microbes and that can be adapted for use in manufacturing materials, which overcome the disadvantages and defects of the prior art, especially regarding the incorporation of selenium-based biocidal formulations with coatings of various forms or types.

### IV. SUMMARY OF THE INVENTION

In one embodiment of the coating composition, the composition coating comprises a covalent linkage of an anchor group to the surface of a substrate, wherein the active group comprises an organic selenium compound acting as a biocidal composition attached to the anchor group, the organic selenium compound comprising at least one of: (1) diselanediylbis(2-hydroxypropane-3,1-diyl)bis(2-methylacrylate); and (2) 3,3′-diselanediylbis(propane-1,2-diol). It is further envisioned that the substrate comprises a metallic composition. It is further envisioned that the metallic composition comprises a titanium coating.

In another embodiment, a method of making a coating composition comprising the steps of: etching a surface, linking of an anchor group to the surface through a covalent linkage the anchor group to the surface, attaching the active group of an organic selenium compound to the anchor group, the organic selenium compound comprising at least one of: (1) diselanediylbis(2-hydroxypropane-3,1-diyl)bis(2-methylacrylate); and (2) 3,3′-diselanediylbis(propane-1,2-diol). It is further envisioned that the method comprises the additional step of applying a metallic coating. It is further envisioned that the metallic coating comprises a titanium coating.

### V. BRIEF DESCRIPTION OF THE DRAWING(S)

FIG. 1 depicts the catalytic cycle of selenium and is embedded within the description of the embodiment(s) below.

### VI. DESCRIPTION OF THE EMBODIMENT(S)

In accordance with embodiment of the present disclosure, a coating composition is described, wherein a coating composition includes a wide-variety of compositions, including application to a substrate as a liquid, solid, and/or gas, as well as for the wide-variety of functional and/or aesthetic purposes generally understood as attributed to coatings, and includes but is not limited to the following functions and/or purposes: protection and/or preservation, such as sealing for anti-corrosion and/or anti-friction protection, decoration, the addition of certain properties and/or characteristics, such as magnetic, conductive, and/or insulative qualities, or adhesive and/or non-adhesive (releasable) qualities. More particularly, but non-limiting, coatings include paints of various varieties and types, such as water-based and oil-based interior and/or exterior paints, lacquers, varnishes, and/or enamels, as well as industrial coating applications utilizing polymers (e.g., epoxy, polyurethane, fluoropolymer, and/or moisture cure urethane).

More specifically, the coating composition comprises a substrate having a surface, the substrate formed from at least one of: (i) a solvent and/or solvents; (ii) a binding agent and/or binding agents; (iii) a pigment and/or pigments; and/or (iv) an additive and/or additives. The coating composition also comprises a biocidal composition disposed on the surface of the substrate and/or impregnated throughout the substrate, the biocidal composition comprising at least one of: (i) diselanediylbis(2-hydroxypropane-3,1-diyl)bis(2-methylacrylate); and (ii) 3,3′-diselanediylbis(propane-1,2-diol).

Coatings and/or paints share common compositional elements, usually a combination of solid starting material and liquid starting material, with slight variations in each dependent upon purpose and/or function of the end-product. For example, coatings and paints each generally comprise of one or more liquid carriers or solvents, wherein carriers and solvents are similar liquid components, though the idiomatic language of each industry tends to divide along “carrier” for coatings-products and “solvents” for the more specific paint-products. Carriers or solvents influence the viscosity and/or cure-time of the end-product composition, but includes compromises for ease of application, drying-time, and environmental impact concerns, among others. Coatings and paints also include some solid constituent components, including some binders (resins polymerized to form polymers), pigments, and/or additives, although each of these may also comprise some or all liquid composition. The binder (resin-to-polymer) assists in evenly dispersing any pigment(s), provides proper adhesion to the substrate to which the coating or paint is applied, and assists in forming the continuous film on the substrate. Pigment(s) is/are included for color and/or opacity. Additives can include a variety of materials that add certain desirable qualities and/or characteristics, such as UV and/or anti-corrosion protection, product flow and/or ease of application, and product finish appearance post-cure.

It is envisioned that the coatings composition may be made or manufactured according to a unique process. In one embodiment, a process or method of making a coating composition comprises the steps of combining liquid starting materials and solid starting materials. The liquid starting materials comprises carrier or solvents for diluting and/or thinning the coating composition. The solid starting materials comprises binder agents (polymers), pigments, and additives. The liquid starting materials and solid starting materials are mixed after combining. At one of several possible stages, a quantity of a biocidal composition for disposition on or impregnation throughout a substrate formed from the liquid starting materials or the solid starting materials is incorporated into the starting materials, wherein the biocidal composition comprising at least one of: (i) diselanediylbis(2-hydroxypropane-3,1-diyl)bis(2-methylacrylate) and (ii) 3,3′-diselanediylbis(propane-1,2-diol).

It is envisioned that there are multiple introduction and incorporation stages of the biocidal composition into the process or method of making a coating composition. For example, it is envisioned that the biocidal composition may be introduced to the liquid starting materials or the solid starting materials, and before the starting materials are introduced or combined with one another. In another example, it is envisioned that the biocidal composition may be introduced concurrent to or immediately following the introduction and combination of the starting materials. In another example, it is envisioned that the biocidal composition may be introduced after the starting materials are mixed. In another example, it is envisioned that the biocidal composition may be introduced after the starting materials are mixed and formation of a coating composition (without the biocidal composition) occurs.

The utilization of a selenium-based biocidal composition (or compositions) integrated within a coating composition is intended to provide a coating product that can be utilized on multiple surfaces and/or substrates to neutralize and/or destroy harmful infectious disease (whether bacterial, viral, fungal, or protozoan) or neutralize and/or destroy harmful biofilm formation that may pre-exist the application of the coating material to the surface or substrate and continues to exhibit and function as a biocidal agent, whether as a bacterialcidal, a viralcidal, a fungicidal, and/or a protozoacidal agent or otherwise an agent that prevents formation and growth of biofilm on coated articles.

As noted, it is envisioned that the biocidal compositions comprise a selenium-based composition. Broadly, the biocidal compositions include at least one selenium atom that is capable of forming the species Se⁻ and thus results in free radical generation that is damaging to any species of interest if the Se⁻ is available to a surface of the species of interest in a proximity that allows for free radical catalysis to be performed. In addition to the selenium atom, the biocidal composition contains three functional groups. In particular embodiments, the biocidal composition possesses the following formula:

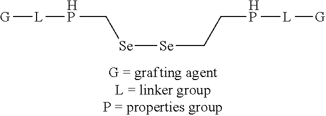

The grafting agent, the linker group, and the properties group represent the three functional groups of the biocidal composition. These three groups modulate properties of the biocidal composition to “fine tune” the biocidal composition and provide compatibility with a substrate on which the biocidal composition is disposed (such as, for example but not by way of limitation, a thermoplastic resin from which a substrate having the biocidal composition incorporated therein is formed, or a liquid substrate in which the biocidal composition is disposed).

The grafting agent is a first functional group that attaches the biocidal composition to the substrate. In certain embodiments, the grafting agent is selected from the group consisting of vinyl, acrylate, methacrylate, acrylamide, vinyl, alcohol, amine, carboxylic acid, ester, amide, ether, acid chloride, N-hydroxysuccinimide activated esters, and combinations thereof. The grafting agent may interact with a molten polymer from which a substrate is formed, or the grafting agent may graft to functional groups within a polymer or monomer composition from which a substrate is formed. In certain embodiments, the grafting agent covalently attaches the biocidal composition to the substrate.

The linker group is a second functional group that modulates solubility of the biocidal composition. The linker group is an organic group that may contain 2-20 carbons (such as but not limited to, 4-10 carbons), with the length of this group being dependent upon the end application. While the linker group is chosen for its solubilizing properties, it may also function to maximize the percentage of selenium in the biocidal compound. For example, the percentage of selenium in the biocidal composition may be in a range of from 15% to 60%, or 30% to 55%. In certain embodiments, the linker group is selected from the group consisting of linear aliphatic chains, branched aliphatic chains, ring structures, and combinations thereof. The ring structures may be aromatic, such as, but not limited to, benzene and toluene derivatives; these derivatives may be attached in certain embodiments through the 1 and 4 positions. However, when geometry of the structure is key to the application, the attachment points could be 1,2; 1,3; 1,5; 2,5; or any such combination that creates the preferred geometry to maximize the activity of the selenium atoms in the compositions. Aromatic rings may also be benzene, toluene, xylene, naphthalene or anthracene through attachment points. In the rings possessing 2 or more rings, the attachment points can be, for example but not by way of limitation, 1,8; 2,9; 2,7; and the like.

The linker group is chosen to provide compatibility with the material from which the substrate is formed (such as, but not limited to, a resin of choice). For example but not by way of limitation, when the substrate is produced from organic media ranging from solvents to polymers, the solubility of the linker group is chosen to maximize compatibility with this media (i.e., hydrophobic linker groups are utilized with hydrophobic resins). When the substrate is produced from more hydrophilic resins, the L group may possess additional functionality, such as, but not limited to, alcohol, amine or phenol groups, to aid in compatibility of the biocidal composition with the substrate.

The properties group is a third functional group that modulates physical properties of the biocidal composition, including but not limited to the boiling point, volatility, and/or solubility. In certain embodiment, the properties group is selected from the group consisting of alcohols, amines, carboxylic acids, and combinations thereof. For example but not by way of limitation, alcohol groups may be chosen to increase the boiling point; this modulated property makes the compound less volatile and aids in high temperature processing to minimize fumes of the resultant organoselenium species. In addition, the properties group may also act in concert with the linker group to modulate solubility.

Particular examples of biocidal compositions in accordance with the presently disclosed and claimed inventive concept(s) that possess the three functional groups and selenium compounds include, but not limited to, diselanediylbis(2-hydroxypropane-3,1-diyl)bis(2-methylacrylate) and 3,3′-diselanediylbis(propane-1,2-diol).

Examples of aqueous and non-aqueous applications of the biocidal compositions of the presently disclosed and claimed inventive concept(s) are in particular, but not limited to, surface coatings, protective paints, and other coatings in the following: roofing, basements, walls, facades, greenhouses, sun protection, garden fencing, wood protection, tent roof material, antifouling marine protection, fabrics; sanitary: public conveniences, bathrooms, shower curtains, toilet items, swimming pools, saunas, jointing, sealing compounds; requisites for daily life, machines, kitchen, kitchen items, sponge pads, recreational products for children, packaging for food or drink, milk processing, drinking water systems, cosmetics; machine parts: air conditioning systems, ion exchangers, process water, solar-powered units, heat exchangers, bioreactors, membranes (including but not limited to, membranes utilized in filtration devices such as ultrafiltration, microfiltration, and nanofiltration devices); medical technology: contact lenses, bandages, diapers, membranes, implants; consumer articles: automobile seats, clothing (socks, sports clothing, and the like), hospital equipment, door handles, telephone handsets, public conveyances, animal cages, cash registers, carpeting, wallpapers; boat hulls, docks, buoys, drilling platforms, ballast water tanks construction; and the like.

In one aspect, the presently disclosed and claimed inventive concept(s) provides a method of treating or preventing growth of a species of interest through contact of a subject with a biocidal composition as described in detail herein, wherein the selenium composition comprises an inorganic or organic selenium compound, or formulation thereof, capable of generating superoxide radicals in the presence of a species of interest. The superoxide radicals generated by the inorganic or organic selenium compound inhibit or inactivate an agent of the species of interest and thereby treat or prevent growth of the species of interest in or on the subject.

In another aspect, the presently disclosed and claimed inventive concept(s) provides a method of treating or preventing the development or transmission of a species of interest in or on a subject through the use of a biocidal composition comprising a selenium composition as described in detail herein, wherein the selenium composition comprises an organic selenium compound, or formulation thereof, capable of generating superoxide radicals in the presence of a species of interest. The method involves providing the biocidal composition capable of generating superoxide radicals in the presence of an infectious agent, and applying an effective amount of the biocidal composition to the subject. The superoxide radicals generated by the organic selenium compound inhibit or inactivate the species of interest and thereby treat or prevent the growth or transmission of the species of interest in the subject.

In a further aspect, the presently disclosed and claimed inventive concept(s) provides biocidal compositions having, on at least one surface thereof, an effective amount of an inorganic or organic selenium compound, or formulation thereof, capable of generating superoxide radicals in the presence of a species of interest or reduced thiol compound or other electron donating group. The organic selenium compound may be covalently or non-covalently associated with the composition, and an effective amount of the organic selenium compound, or formulation thereof, is retained on or available to a surface of the composition when the composition is in contact with a subject.

In particularly useful embodiments of the biocidal compositions of the presently disclosed and claimed inventive concept(s), the effective amount of the organic selenium compound, or formulation thereof, that is retained on or available to a surface of the composition when such composition is in contact with the subject is sufficient to inhibit or inactivate an agent of infectious disease or other undesired cell(s).

In other embodiments, the organic selenium compound, or formulation thereof, does not comprise a thiol group or a thiol-containing compound. In particular embodiments, the organic selenium compound, or formulation thereof, does not comprise glutathione.

In other embodiments, the organic selenium compound, or formulation thereof, eliminates undesirable biological inhabitation including bacterial biofilm, fungi or other biologic colonization on surfaces. The organic selenium compound(s) is/are efficacious against gram negative and gram-positive bacteria, fungi, viruses and neoplastic growth. The organic selenium compound is a catalytic antimicrobial, therefore once the compound is incorporated into or coated onto a given substrate, it will remain active for an extensive period of time.

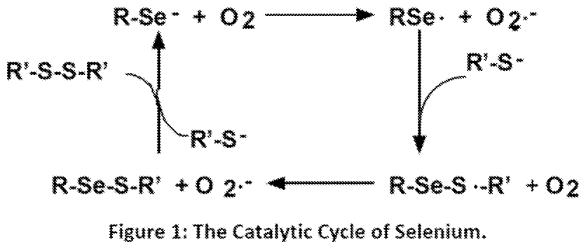

As best illustrated by FIG. 1, an organoselenium molecule (RSeH) is catalytic and produces superoxide by its interaction with thiols, which are ubiquitous in the environment as they are found in all body fluids, as well as on the surface of the bacteria themselves. The selenium compound catalyzes the formation of two moles of superoxide radical for every two moles of thiol compound, yet the selenium compound is unchanged. Since the superoxide radicals are catalytically generated without depleting the base compound, the antimicrobial benefit is effectively permanent, although this may depend on the resilience of the substrate itself in some cases. This is perhaps the most unique characteristic of selenium: many metals can act as catalysts, but none have been shown to catalyze the production of antimicrobial compounds from naturally occurring compounds while remaining covalently bound to a substrate.

An important characteristic of the superoxide radical is that it has a short half-life in micro-seconds at high concentrations (>100 uM). Thus, it cannot damage remote organisms or create systemic toxicity since its path-length at effective concentrations is too short. Since the superoxide radical has only a very short diffusion lifetime, the organic selenium coatings will be only locally active and will not adversely affect non-attached cells or organisms, with an absolute maximum range measured in millimeters (some bacterial strains are highly sensitive to superoxide and its descendent species, even at nanomolar concentrations).

FIG. 1 (the catalytic cycle of selenium) illustrates how selenium catalyzes a short-range antimicrobial effect against microorganisms. As a surface coating, the organic selenium compound can be applied across the entire surface or limited to certain areas. This is significant in industrial applications, especially in bioreactors, where some portions of a waste or nutrient stream need to be able to flow (where the organic selenium compound(s) can ensure that there is no biofilm growth to foul pipes, filter membranes, etc.), while other areas require bacteria growth, such as chambers that are used to break down waste or create useful products.

In furtherance of an effective biofilm inhibiting coating, it is envisioned that a two-step coating process consists of an initial surface etch followed by a covalent linkage of an anchor group to the surface. The active group of the organic selenium compound is attached to the anchor. Then, a one-step coating utilizing titanium is performed. This coating procedure is envisioned as a “spray and dry” formulation that can be rolled out on a large scale in numerous applications in both new and existing infrastructure.

In one embodiment, a coating composition comprises a covalent linkage of an anchor group to the surface of a substrate, wherein the active group comprises an organic selenium compound acting as a biocidal composition attached to the anchor group, the organic selenium compound comprising at least one of: (i) diselanediylbis(2-hydroxypropane-3,1-diyl)bis(2-methylacrylate); and (2) 3,3′-diselanediylbis(propane-1,2-diol). It is further envisioned that the substrate comprises a metallic composition. It is further envisioned that the metallic composition comprises a titanium coating.

In another embodiment, a method of making a coating composition comprising the steps of: etching a surface, linking of an anchor group to the surface through a covalent linkage the anchor group to the surface, attaching the active group of an organic selenium compound to the anchor group, the organic selenium compound comprising at least one of: (1) diselanediylbis(2-hydroxypropane-3,1-diyl)bis(2-methylacrylate); and (2) 3,3′-diselanediylbis(propane-1,2-diol). It is further envisioned that the method comprises the additional step of applying a metallic coating. It is further envisioned that the metallic coating comprises a titanium coating.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing FIGURES that may be provided are for illustrative purposes only, and merely provide practical examples of the invention disclosed herein. Therefore, any drawing FIGURES provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

1. A coating composition, comprising:
a covalent linkage of an anchor group to the surface of a substrate, wherein the active group comprises an organic selenium compound acting as a biocidal composition attached to the anchor group, the organic selenium compound comprising at least one of:
(1) diselanediylbis(2-hydroxypropane-3,1-diyl)bis(2-methylacrylate); and
(2) 3,3′-diselanediylbis(propane-1,2-diol).

2. The composition of claim 1, wherein the substrate comprises a metallic composition.

3. The composition of claim 2, wherein the metallic composition of the substrate comprises a titanium coating.

4. A method of making a coating composition comprising the steps of:
etching a surface;
linking of an anchor group to the surface through a covalent linkage the anchor group to the surface;
attaching the active group of an organic selenium compound to the anchor group, the organic selenium compound comprising at least one of
(1) diselanediylbis(2-hydroxypropane-3,1-diyl)bis(2-methylacrylate); and
(2) 3,3′-diselanediylbis(propane-1,2-diol).

5. The method of making the coating composition of claim 4, further comprising the step of applying a metallic coating.

6. The method of making the coating composition of claim 5 wherein the metallic coating comprises a titanium coating.
